(19) United States
(12) Patent Application Publication
(10) Pub. No.: US 2023/0018643 A1
(43) Pub. Date: Jan. 19, 2023

(54) RETRACTABLE CARD READERS

(71) Applicant: Hewlett-Packard Development Company, L.P., Spring, TX (US)

(72) Inventors: Chung-Hua KU, Taipei City (TW); Wei-Ming TSENG, Taipei City (TW); Shih-Hua CHANG, Taipei City (TW)

(21) Appl. No.: 17/785,016

(22) PCT Filed: Dec. 13, 2019
(86) PCT No.: PCT/US2019/066175

§ 371 Date: Jun. 13, 2022

(51) Int. Cl. G06K 13/08

(52) U.S. Cl. CPC G06K 13/0812; G06K 13/0831

(57) ABSTRACT

A retractable card reader is described herein. In some examples, the retractable card reader can comprise a reader body having an incision to insert a card and a rotatable bracket attached to the reader body to guide the card into the reader body.

### BACKGROUND

Computing devices may include a card reader. Card readers may be used with smart cards, which are cards with a built-in chip used for electronic processes including personal identification, data storage, access control, authentication, financial transactions, and application processing. Applications may include identification, financial, mobile phones (SIM), public transit, computer security, schools, and healthcare. Card readers may obtain or “read” this type of data.

### BRIEF DESCRIPTION OF THE DRAWINGS

FIG. 1 is a section view of an example of a computing device having a retractable card reader consistent with the disclosure

FIG. 2 is an example of a system including a computing device having a retractable card reader consistent with the disclosure.

FIG. 3 is a section view of an example of a retractable card reader consistent with the disclosure.

FIG. 4 is a section view of an example of retractable card reader consistent with the disclosure.

FIG. 5 is a section view of an example of a retractable card reader consistent with the disclosure.

FIG. 6 is a section view of an example of retractable card reader consistent with the disclosure.

### DETAILED DESCRIPTION

As used herein, the term “card” refers to a physical electronic authorization device, used to control access to a resource. A card may be a credit card-sized card with an embedded integrated circuit (IC) chip. Some cards may include a pattern of metal contacts to electrically connect to the internal chip while other cards may be contactless. A card can be, for example, a smart card, a chip card, an integrated circuit card (ICC), among other types of cards. As used herein, the term “card reader” refers to an electric device that can establish a communication path between the card and a computing device. As used herein, the term “computing device” refers to an electrical device that can include a processing resource and a memory resource to perform particular functions. For example, the computing device can be a portable personal computing device. A computing device can be, for example, a laptop computer and/or a notebook, among other types of computing devices.

In some examples, a computing device can include a card reader permanently positioned internally. In such an example, a card may be inserted into the computing device allowing the card reader to read the card. As the card is inserted into the computing device, the computing device may include an opening and a cavity that occupies a space large enough to receive the card. A tradeoff of the layout space of a card and reader may include battery life and antenna performance, among other functions of the computing device. Additionally, the opening of the cavity may limit the amount of available space on a surface of the computing device to display identification (ID) features, such as an ID side band.

A computing device having a retractable card reader, according to the disclosure, can allow for improved battery life and/or antenna performance, among other functions of the computing device. For instance, the increased performance may be due to additional real estate that can be used to increase the performance (e.g., larger battery, etc.). Accordingly, the retractable card reader can include a reader body having an incision to insert a card and a rotatable bracket attached to the reader body to guide the card into the reader body,

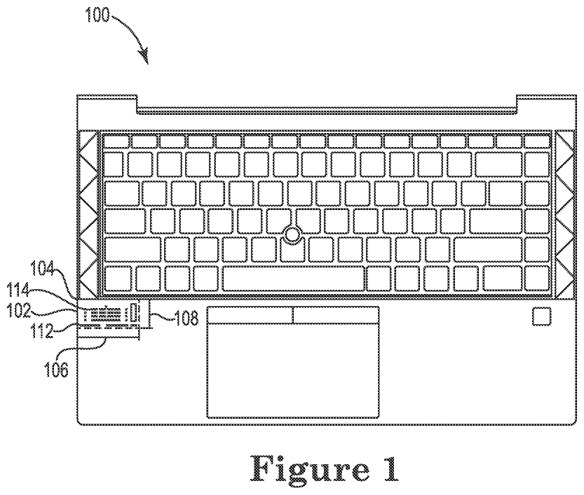

FIG. 1 is a section view of an example of a computing device 100 having a retractable card reader 102 consistent with the disclosure. The retractable card reader 102 may include a reader body 114 having an incision to insert a card and a rotatable bracket 112 attached to the reader body 114 to guide the card into the reader body 114.

In some examples, the computing device 100 can include a processing resource and/or a memory resource storing instructions to perform particular functions. A processing resource, as used herein, can include a number of processing resources capable of executing instructions stored by a memory resource. The instructions (e.g., machine-readable instructions (MRI), computer-readable instructions (CRI), etc.) can include instructions stored on the memory resource and executable by the processing resource to perform or implement a particular function. The memory resource, as used herein, can include a number of memory components capable of storing non-transitory instructions that can be executed by the processing resource.

The memory resource can be in communication with the processing resource via a communication link (e.g., communication path). The communication link can be local or remote to an electronic device associated with the processing resource. The memory resource includes instructions. In some examples, instructions (e.g., software, firmware, etc.) can be downloaded and stored in memory resource (e.g., MRM) as well as a hard-wired program (e.g., logic), among other possibilities. In other examples, the controller can be hardware, such as an application-specific integrated circuit (ASIC), that can include instructions to perform particular functions.

As illustrated in FIG. 1, the retractable card reader 102 may be positioned within a cavity 104 of the computing device 100. The cavity 104 of the computing device 100 may be based on the size of the retractable card reader 102. For instance, a depth 106 of the cavity 104 may be based on a length of the retractable card reader 102 and the width 108 of the cavity 104 may be based on the width of the retractable card reader 102. The cavity 104 being based on the size of the retractable card reader 102 may allow for saved layout space within the computing device 100, which may result in improved battery life and/or antenna performance, among other functions of the computing device 100.

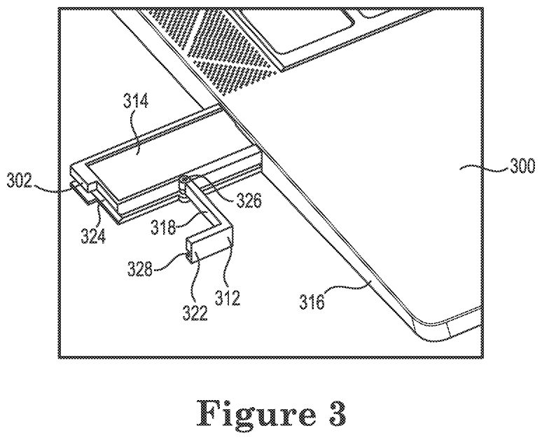

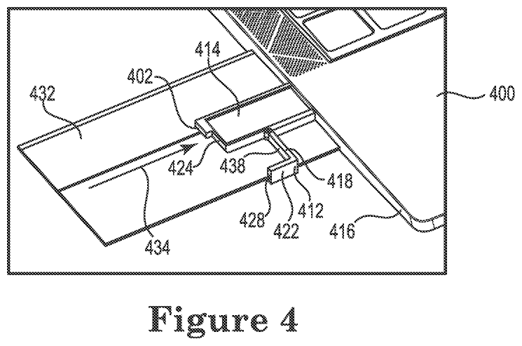

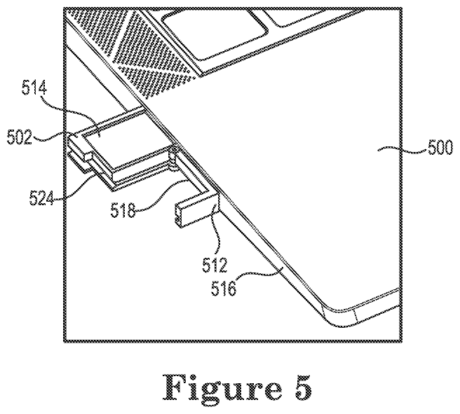

The retractable card reader 102 may be slidable within the cavity 104 of the computing device 100. For instance, the retractable card reader 102 may be slidable between a first position and a second position. As illustrated in FIG. 1, when in the first position, the retractable card reader 102 may be positioned within the computing device 100 allowing the retractable card reader 102 to be stored within the computing device 100 when not in use. As illustrated in FIGS. 3 and 4, when in the second position, the retractable card reader 102 may be protruding from the computing device 100 so that the retractable card reader 102 is positioned outside of the computing device 100 allowing a card (e.g., card 532 illustrated in FIG. 5) to be inserted into the retractable card reader 102 without being inserted into the computing device 100. The cavity 104 may include a system utilized to allow the retractable card reader 102 to slide from the first position to the second position, such as a rail or track. However, this disclosure is not so limited.

As illustrated in FIG. 1, the retractable card reader 102 may include the reader body 114 to detect a card (e.g., a smart card) and read data stored on the card. For example, as described herein (e.g., with connection to FIG. 4), the reader body 114 may include an incision (e.g., a card slot) to receive the card. While not illustrated, within the incision, the reader body 114 may include a reader unit to read the chip (e.g., an IC chip) embedded within the card. As used herein, the term “reader unit” refers to electric circuitry, such as a circuit board, allowing communication between the reader body and the chip embedded within the card. Thus, when the card is inserted into the incision of the reader body 114, the reader unit may make contact with the chip embedded within the card allowing the computing device 100 to receive data from the card. The data may be associated with personal identification, access control, authentication, and financial transactions, among other data that may be stored by a card.

As illustrated in FIG. 1, the retractable card reader 102 may include a rotatable bracket 112, As used herein, the term “bracket” refers to a physical structure of a retractable card reader to guide a card into a reader body, as well as providing physical support while the card is inserted into the retractable card reader 102. The rotatable bracket 112 may be attached to the reader body via a hinge (e.g., hinge 326 illustrated in FIG. 3). As used herein, the term “hinge” refers to a physical structure of a retractable card reader 102 that attaches the rotatable bracket 112 to the reader body 114 allowing the rotatable bracket 112 to rotate. When the retractable card reader 102 is positioned within the computing device 100, the rotatable bracket 112 may be positioned flush against (e.g., adjacent to) the reader body 114. The rotatable bracket 112 may be an L-shaped bracket that may rotate ninety degrees as the retractable card reader 102 slides from the first position (e.g., within the computing device 100) to the second position (e.g., protruding from the computing device 100).

A first portion of the rotatable bracket 112 may be perpendicular to the insertion direction (e.g., insertion direction 434 illustrated in FIG. 4) of the card and a second portion of the bracket may be parallel to the insertion direction of the card when the retractable card reader 102 is positioned within the computing device 100. As the retractable card reader 102 is withdrawn from the computing device 100, the rotatable bracket 112 may rotate ninety degrees until the first portion of the rotatable bracket 112 is parallel to the insertion direction of the card and the second portion of the rotatable bracket 112 is perpendicular to the insertion direction of the card.

When the retractable card reader 102 is protruding from the computing device 100, the rotatable bracket 112 may be used to guide the card into the incision of the reader body 114. For example, a first portion of the rotatable bracket 112 may include a groove to guide the card into the retractable card reader 102. The groove may be a cutout that extends along the length of the first portion of the rotatable bracket 112. The size of the groove may be based on the size of a card. For example, the groove may correspond to a thickness of the card allowing the groove to receive a portion of the card and to guide the card into an incision of a second portion of the rotatable bracket 112 and the incision of the reader body 114.

The second portion of the rotatable bracket 112 may include an incision allowing the card to bypass the second portion of the rotatable bracket 112 and be positioned within the incision of the reader body 114. The incision of the second portion of the rotatable bracket 112 may be aligned with the incision of the reader body 114. The length of the second portion of the rotatable bracket 112 may be half the length of the retractable card reader 102.

While not illustrated, in some examples, the computing device 100 may incorporate a push-to-open mechanism within the cavity 104 to move the retractable card reader 102 from the first position to the second position. However, this disclosure is not so limited. In such an example, the retractable card reader 102 may include a pressing unit. As used herein, the term “pressing unit” refers to a physical structure of the retractable card reader 102. The pressing unit may be located on a surface of the retractable card reader 102 that is accessible to a user when the retractable card reader is positioned within the computing device 100. The retractable card reader 102 may retract (e.g. eject) from the computing device 100 in response to pressure being applied to the pressing unit. Additionally, pressure may be applied to the retractable card reader 102 in the insertion direction of the card causing the retractable card reader 102 to be positioned within the computing device 100 when the retractable card reader 102 is not in use.

In some examples, the retractable card reader 102 may slide between the first position to the second position by manually pushing and pulling the retractable card reader 102. In such an example, the retractable card reader 102 may include a pulling unit. As used herein, the term “pulling unit” refers to a physical structure of the retractable card reader 102. The pulling unit may be located on a surface of retractable card reader 102 that is accessible to a user when the retractable card reader 102 is positioned within the computing device 100. For example, the pulling unit may protrude from the retractable card reader 102 allowing a user to grasp the pulling unit when the retractable card reader 102 is positioned within the computing device 100. The retractable card reader 102 may retract (e.g. eject) from the computing device 100 in response to manually pulling the pulling unit until the retractable card reader 102 is protruding from the computing device 100. Additionally, pressure may be applied to the retractable card reader 102 in the insertion direction of the card causing the retractable card reader 102 to be positioned within the computing device 100 when the retractable card reader 102 is not in use.

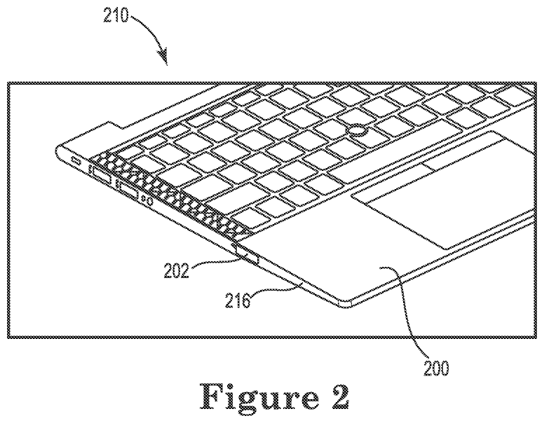

FIG. 2 is an example of a system 210 including a computing device 200 having a retractable card reader 202 consistent with the disclosure. The retractable card reader 202 may include a reader body having an incision to insert a card and a rotatable bracket attached to the reader body to guide the card into the reader body.

As described above (e.g., in connection with FIG. 1), the retractable card reader 202 may be positioned within a cavity of the computing device 200, where the size of the cavity may be based on the size of the retractable card reader 202. The cavity being based on the size of the retractable card reader 202 may allow for saved layout space within the computing device 200, which may result in improved battery life and/or antenna performance, among other functions of the computing device 200.

The retractable card reader 202 may be slidable within the cavity of the computing device 200. For instance, the retractable card reader 202 may be slidable between a first position and a second position. As described above (e.g., in connection with FIG. 1), the computing device 200 may incorporate a push-to-open mechanism to move the retractable card reader 202 from the first position to the second position. However, this disclosure is not so limited. As illustrated in FIG. 2, when in the first position, the retractable card reader 202 may be positioned within the computing device 200 allowing the retractable card reader 202 to be stored within the computing device 200 when not in use.

As illustrated in FIG. 2, when the retractable card reader 202 is positioned within the computing device 200, the retractable card reader 202 may be accessible via a surface 216 of the computing device 200. For instance, the retractable card reader 202 may retract from the cavity of the computing device 200 and protrude from the surface 216. The opening of the cavity may be located on the surface 216, where the opening may be based on the width of the retractable card reader 202. The saved layout space on the surface 216 of the computing device 200 may allow for additional space to display ID features, such as an ID side band. As described above (e.g., in connection with FIG. 1), the retractable card reader 202 may include a reader body and a rotatable bracket.

FIG. 3 is a section view of an example retractable card reader 302 consistent with the disclosure. The retractable card reader 302 may include a reader body 314 having an incision 324 to insert a card and a rotatable bracket 312 attached to the reader body 314 to guide the card into the reader body 314.

As described above (e.g., in connection with FIG. 1) the retractable card reader 302 may be positioned within a cavity of the computing device 300. The retractable card reader 302 may be slidable within the cavity of the computing device 300. For instance, the retractable card reader 302 may be slidable between a first position (e.g., as illustrated in FIGS. 1 and 2) and a second position. As illustrated in FIG. 3, when in the second position, the retractable card reader 302 may be protruding from a surface 316 of the computing device 300 so that the retractable card reader 302 is positioned outside of the computing device 300 allowing the reader body 314 and the rotatable bracket 312 to be accessible.

As illustrated in FIG. 3, the retractable card reader 302 may include the reader body 314 to detect a card and read data stored on the card. The reader body 314 may include an incision 324 to receive the card. When the card is inserted into the incision 324 of the reader body 314, a reader unit may make contact with a chip embedded within the card allowing the computing device 300 to receive data from the card.

As illustrated in FIG. 3, the retractable card reader 302 may include a rotatable bracket 312, where the rotatable bracket 312 may be attached to the reader body 314 via a hinge 326. The rotatable bracket 312 may be an L-shaped bracket that may rotate ninety degrees as the retractable card reader 302 slides from the first position (e.g., within the computing device 300) to the second position (e.g., protruding from the surface 316 of the computing device 300).

As the retractable card reader 302 is withdrawn from the computing device 300, the rotatable bracket 312 may rotate until the first portion 322 of the rotatable bracket 312 is parallel to the insertion direction (e.g., insertion direction 434 illustrated in FIG. 4) of the card and the second portion 318 of the rotatable bracket 312 is perpendicular to the insertion direction of the card. When the retractable card reader 302 is protruding from the surface 316 of the computing device 300, the rotatable bracket 312 may be used to guide the card into the incision 324 of the reader body 314. For example, a first portion 322 of the rotatable bracket 312 may include a groove 328 to guide the card into the incision 324 of the reader body 314.

The second portion 318 of the rotatable bracket 312 may include an incision (e.g., incision 438 illustrated in FIG. 4) allowing the card to bypass the second portion 318 of the rotatable bracket 312 and be positioned within the incision 324 of the reader body 314. The length of the second portion 318 of the rotatable bracket 312 may be half the length of the retractable card reader 302.

FIG. 4 is a section view of an example of a retractable card reader 402 consistent with the disclosure. The retractable card reader 402 may include a reader body 414 having an incision 424 to insert a card 432 and a rotatable bracket 412 attached to the reader body 414 to guide the card 432 into the reader body 414.

As described herein, the retractable card reader 402 may be slidable between a first position and a second position within a cavity of the computing device 400. As described above (e.g., in connection with FIG. 1), the cavity of the computing device 200 may incorporate a push-to-open mechanism to move the retractable card reader 202 from the first position to the second position. However, this disclosure is not so limited. As illustrated in FIG. 4, when in the second position, the retractable card reader 402 may be protruding from a surface 416 of the computing device 400 so that the retractable card reader 402 is positioned outside of the computing device 400 allowing the reader body 414 and the rotatable bracket 412 to be accessible.

The retractable card reader 402 may include the reader body 414 to detect the card 432 and read data stored on the card 432. For example, the reader body 414 may include an incision 424 to receive the card 432. While not illustrated, within the incision, the reader body 414 may include a reader unit to read the chip (e.g., an IC chip) embedded within the card 432. Thus, when the card is inserted into the incision 424 of the reader body 414, the reader unit may make contact with the chip embedded within the card 432 allowing the computing device 400 to receive data from the card 432. The data may be associated with personal identification, access control, authentication, and financial transactions, among other data that may be stored by a card.

The retractable card reader 402 may include a rotatable bracket 412, where the rotatable bracket 412 may be an L-shaped bracket that may rotate as the retractable card reader 402 retracts from the computing device 400. For example, as the retractable card reader 402 is withdrawn from the computing device 400, the rotatable bracket 412 may rotate ninety degrees until a first portion 422 of the rotatable bracket 412 is parallel to the insertion direction 434 of the card 432 and the second portion 418 of the rotatable bracket 412 may be perpendicular to the insertion direction 434 of the card 432.

The rotatable bracket 412 may be used to guide the card 432 into the incision 424 of the reader body 414. For example, the first portion 422 of the rotatable bracket 412 may include a groove 428 to guide the card into the card reader. The groove 428 may be a cutout that extends along the length of the first portion 422 of the rotatable bracket 412. The size of the groove 428 may be based on the size of a card 432. For example, the groove 428 may correspond to a thickness of the card 432 allowing the groove 428 to receive a portion of the card 432 and to guide the card 432 into an incision 438 of a second portion 418 of the rotatable bracket 412 and the incision 424 of the reader body 414.

The incision 438 of the second portion 418 of the rotatable bracket 412 may allow the card 432 to bypass the second portion 418 of the rotatable bracket 412 and be positioned within the incision 424 of the reader body 414. The incision 438 of the second portion 418 of the rotatable bracket 412 may be aligned with the incision 424 of the reader body 414. As illustrated in FIG. 4, the card may be positioned external of the computing device 400 when the reader body 414 is reading the card 432 allowing for saved layout space within the computing device 400, which may result in improved battery life and/or antenna performance, among other functions of the computing device 400.

FIG. 5 is a section view of an example of a retractable card reader 502 consistent with the disclosure. The retractable card reader 502 may include a reader body 514 having an incision 524 to insert a card and a rotatable bracket 512 attached to the reader body 514 to guide the card into the reader body 514.

As described herein, the retractable card reader 502 may be slidable between a first position and a second position within a cavity of the computing device 500. As illustrated in FIG. 5, the retractable card reader 502 may be protruding from a surface 516 of the computing device 500. Pressure may be applied to the retractable card reader 502 in the insertion direction (e.g., insertion direction 434 illustrated in FIG. 4) of the card causing the retractable card reader 502 retract into the cavity of the computing device 500.

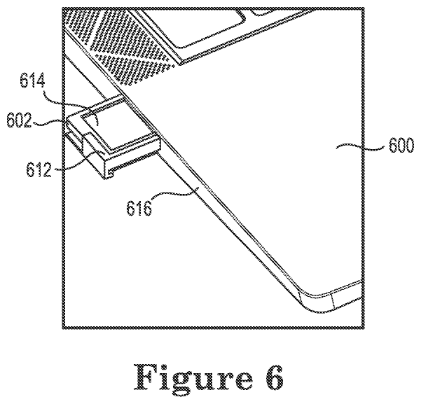

As illustrated in FIG. 5, the retractable card reader 502 may include a rotatable bracket 512, where the rotatable bracket 512 may be an L-shaped bracket. The rotatable bracket 512 may rotate as the retractable card reader 502 retracts into the computing device 500, For example, as the retractable card reader 502 retracts into the computing device, a second portion 518 of the rotatable bracket 512 may make contact with the surface 516 of the computing device 500. The surface 516 of the computing device 500 apply pressure to the second portion 518 of the rotatable bracket 512 forcing the rotatable bracket 512 to rotate until the rotatable bracket 512 is positioned flush against the reader body 514, as illustrated in FIG. 6. This may allow for the retractable card reader 502 to fit within the cavity of the computing device 500.

FIG. 6 is a section view of an example of a retractable card reader 602 consistent with the disclosure. The retractable card reader 602 may include a reader body 614 having an incision to insert a card and a rotatable bracket 612 attached to the reader body 614 to guide the card into the reader body 614.

As illustrated in FIG. 6, the retractable card reader 602 may include a rotatable bracket 612, where the rotatable bracket 612 may rotate as the retractable card reader 602 slides into and out of the computing device 600, The rotatable bracket 612 may be positioned flush against the reader body 614 allowing the retractable card reader 602 to fit within the cavity of the computing device 600.

As described herein, the cavity may be based on the size of the retractable card reader 602 allowing for saved layout space within the computing device 600. Saved layout space may result in improved battery life and/or antenna performance, among other functions of the computing device 600. Additionally, the opening of the cavity may be located on the surface 616 of the computing device, where the opening may be based on the width of the retractable card reader 602. The saved layout space on the surface 616 of the computing device 600 may allow for additional space to display identification (ID) features, such as an ID side band.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electric, and/or structural changes may be made without departing from the scope of the disclosure. Further, as used herein, “a” can refer to one such thing or more than one such thing. Additionally, the designator “N” as used herein, particularly with respect to reference numerals in the drawings, indicates that a number of the particular feature so designated can be included with a number of examples of the present disclosure. This number may be the same or different between designations.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A retractable card reader, comprising:
a reader body having an incision to insert a card; and
a rotatable bracket attached to the reader body to guide the card into the reader body.

2. The retractable card reader of claim 1, wherein the bracket is a L-shaped bracket.

3. The retractable card reader of claim 2, wherein the L-shaped bracket is flush against the reader body when the card reader is positioned within a computing device.

4. The retractable card reader of claim 1, wherein the bracket is attached to the reader body via a hinge.

5. The retractable card reader of claim 1, wherein a first portion of the bracket includes a groove to guide the card into the reader body.

6. The retractable card reader of claim 5, wherein a second portion of the bracket includes an incision to receive the card.

7. The retractable card reader of claim 1, wherein the retractable card reader is slidable within a cavity of a computing device.

8. A system, comprising:
a computing device including a cavity to receive a retractable card reader; and
the retractable card reader including:
a reader body having an incision to insert a card; and
a rotatable bracket attached to the reader body to guide the card into the reader body, wherein the rotatable bracket includes a first portion to guide the card into the reader body and a second portion to receive the card.

9. The system of claim 8, wherein a first portion of the bracket is parallel to an insertion direction of the card and a second portion of the bracket is perpendicular to the insertion direction of the card when the card reader is withdrawn from the computing device.

10. The system of claim 9, wherein the first portion of the bracket is perpendicular to the insertion direction of the card and the second portion of the bracket is parallel to the insertion direction of the card when the card reader is inserted into the computing device.

11. The system of claim 10, wherein a length of the second portion of the bracket is half a length of the retractable card reader.

12. The system of claim 8, wherein a depth of the cavity is based on a length of the retractable card reader.

13. A computing device, comprising:
a cavity to allow a retractable card reader to slide from a first position to a second position; and
the retractable card reader including:
a reader body having an incision to receive a card; and
a rotatable bracket attached to the reader body to guide the card into the reader body, wherein the rotatable bracket rotates ninety degrees as the reader body slides from the first position to the second position.

14. The computing device of claim 13, wherein the computing device incorporates a push-to-open mechanism within the cavity to move the retractable card reader from the first position to the second position.

15. The computing device of claim 13, wherein the retractable card reader slides between the first position to the second position by manually pushing and pulling the reader body.
